(19) United States
(12) Patent Application Publication
(10) Pub. No.: US 2002/0009095 A1
(43) Pub. Date: Jan. 24, 2002

(54) Multicast decomposition mechanism in a hierarchically order distributed shared memory multiprocessor computer system

(76) Inventors: Stephen R. Van Doren, Northborough, MA (US); Simon C. Steely JR., Hudson, NH (US); Madhumitra Sharma, Marlborough, MA (US)

Correspondence Address: CESARI AND MCKENNA, LLP, 88 BLACK FALCON AVENUE, BOSTON, MA, 02210, US

(21) Appl. No.: 09/871,054

(22) Filed: May 31, 2001

Related U.S. Application Data
(60) Provisional application No. 60/208,282, filed on May 31, 2000.

(51) Int. Cl. H04J 3/26

(52) U.S. Cl. 370/432; 370/390

(57) ABSTRACT

A technique decomposes a multicast transaction issued by one of a plurality of nodes of a distributed shared memory multiprocessor system into a series of multicast packets, each of which may further “spawn” multicast messages directed to a subset of the nodes. A central switch fabric interconnects the nodes, each of which includes a global port coupled to the switch, a plurality of processors and memory. The central switch includes a central ordering point that maintains an order of packets issued by, e.g., a source processor of a remote node when requesting data resident in a memory of a home node. The multicast messages spawned from a multicast packet passing the central ordering point are generated according to multicast decomposition and ordering rules of the inventive technique.

### CROSS-REFERENCE TO RELATED APPLICATIONS

The present application claims priority from U.S. Provisional Patent Application Serial No. 60/208,282, which was filed on May 31, 2000, by Stephen Van Doren, Simon Steely, Jr. and Madhumitra Sharma for a MULTICAST DECOMPOSITION MECHANISM IN A HIERARCHICALLY ORDER DISTRIBUTED SHARED MEMORY MULTIPROCESSOR COMPUTER SYSTEM and is hereby incorporated by reference.

### BACKGROUND OF THE INVENTION

1. Field of the Invention

The present invention generally relates to distributed shared memory multiprocessor systems and, in particular, to performance of multicast transactions in a distributed shared memory multiprocessor system that maintains cache coherency and interprocessor communication through the use of ordered channels of transactions through a central switch.

2. Background Information

A distributed shared memory multiprocessor system may comprise a plurality of multiprocessor building blocks or “nodes” interconnected by a central switch which may, in turn, comprise a crossbar switch fabric. Each node may further comprise a plurality of processors and memory interconnected by a local crossbar switch fabric, with each processor having a private cache for storing cache lines (i.e., data blocks) likely to be accessed by the processor. Each processor of the multiprocessor system may modify or update a data block in its cache without reflecting the update (i.e., “writing” the block) to memory. Therefore, the distributed shared memory system typically employs a cache coherency protocol to ensure that the caches of the processors are kept consistent or coherent.

Cache coherency and memory consistency may be maintained in multiprocessor systems through the use of a directory-based cache coherency arrangement where each node includes a directory with a plurality of entries, and each entry corresponds to a data block resident in the memory of that node. Each directory entry, moreover, typically contains an owner field whose content includes an encoded number that indicates the processor or memory having the most up-to-data (i.e., “dirty”) version of the corresponding data block. Each entry further contains a node field for storing a mask that indicates those nodes whose processors (caches) have copies of the dirty block. The mask may comprise a plurality of bits (e.g., “N” bits) where each bit corresponds to one of the nodes in the system.

The multiprocessor system may also be configured to maintain interprocessor communication through the use of at least one ordered channel of transactions and a hierarchy of ordering points. An ordered channel is defined as a uniquely buffered, interconnected and flow-controlled path through the system that is used to enforce an order of requests or references issued from and received by nodes of the system in accordance with an ordering protocol. The hierarchy of ordering points may include local ordering points within each local crossbar switch of each node and a central ordering point within the central crossbar switch of the system. To optimize performance, the system may be biased to perform ordering operations at the local ordering points whenever possible. Local ordering is generally possible whenever a processor accesses a memory address location within its own node. However, local ordering may not be possible when a processor accesses a data block from a memory resident in another node.

In accordance with the cache coherency and memory consistency arrangement, each data block reference to the memory of a given node is accompanied by a reference to the directory location corresponding to the data block. This directory reference consists of a directory lookup, followed by a response determination and a directory update. The response determination typically generates a system response transaction based on the results of the lookup (i.e., based on the contents of the directory). The system response transaction, in turn, comprises one or more components, including: (1) a system command response, (2) a local command response, (3) one or more system probe/invalidate commands and (4) one or more local probe/invalidate commands. The system response transaction may also comprise one or more (1) system consistency messages or (2) local consistency messages. In the cases of both coherency and consistency, “local” messages/responses/commands are distributed within the “home” node, i.e., the node associated with referenced memory block and its directory entry.

In the case of a “write” command in the cache coherency domain, in which the referencing processor seeks to modify the state of the referenced data block, the response determination typically generates a response transaction that is comprised of both a system command response and system probe/invalidate commands. In particular, it will generate a system command response component targeting the node of the processor that sourced the memory reference (and containing the referenced data block) in all cases where the sourcing processor is on a node other the memory block's home node. It will also conditionally generate one or more system probe/invalidate commands based upon the state of the node field of the respective directory entry. More specifically, it will generate one probe/invalidate command for each node whose corresponding bit in the node field is set, excluding the bit assigned to the home node.

In the case of a write command in the memory consistency domain, the response determination typically generates one system consistency message for each of the two following cases: (1) a “remote sourced reference” case and (2) a “remote invalidate target” case. In the “remote sourced reference” case, a referencing processor resides in a node other that the memory block's home node. System consistency messages resulting from this case always target the source processor's node. In the “remote invalidate target” case, processors other than the source processor reside in nodes other than the memory block's home node for which probe/invalidate commands are generated. Although the coherency messages associated with this set target remote nodes, the system consistency messages associated with this set always target the referenced memory block's home node. The set of “remote sourced reference” system consistency messages are fundamental to a nominal, order-based consistency model of a hierarchical arrangement of compute nodes. The set of “remote invalidate target” system consistency messages provides for optimizations that eliminate the need for generating system consistency messages resulting from references between processors and memory block in the same node.

Assuming a system of nodes interconnected by a central switch, an ideal system implementation would be designed such that all system coherency and consistency commands and messages associated with a given memory reference would be combined in a common transaction packet and forwarded to the central switch. At the central switch, the unified transaction packet would be atomically decomposed into components, wherein each component is comprised of one or more of the original coherency and consistency messages and commands, and further wherein each component is targeted at a unique system node. This process is referred to as “multicasting”. To satisfy the conditions of the memory consistency model, the decomposition of the unified transaction must be performed such that all response transactions from other system nodes that are perceived to have occurred before the unified transaction, or at least one of its components, at a given one of the unified transaction's target nodes must also be perceived as having happened before the components which contain the consistency messages at their target nodes. In practice, this requires the central switch to effectively create a single, bus-like, ordering of system transactions, and to issue the various components of unified transactions to the various switch outputs in accordance with this single ordering.

To meet the such consistency requirements, the central switch must be able to decompose a given transaction and provide resources to maintain a consistent ordering on each individual component of the transaction. Therefore, as the number of nodes in the system increases and the number of potential unified transaction components increases, so too does the resource burden on the implementation of the central switch. As a result, a central switch implementation may not be able to support transactions with more than 3 or 4 components, limiting multiprocessor systems to no more than 3 or 4 nodes.

Workload characterization, however, indicates that less than 5% of write transactions generate unified transactions with greater than 3 components. Further, read transactions never generate unified transactions with greater than 3 components. Therefore a multicast solution is needed that can support the system's memory consistency model, while efficiently employing multicast transactions targeted at a subset of the system nodes.

### SUMMARY OF THE INVENTION

The present invention comprises to a technique for decomposing a multicast transaction issued by one of a plurality of nodes of a distributed shared memory multiprocessor system into a series of multicast packets, each of which may further “spawn” multicast messages directed to a subset of the nodes. A central switch fabric interconnects the nodes, each of which includes a global port coupled to the switch, a plurality of processors and memory. The central switch includes a central ordering point that maintains an order of packets issued by, e.g., a source processor of a remote node when requesting data resident in a memory of a home node. The multicast messages spawned from a multicast packet passing the central ordering point are generated according to multicast decomposition and ordering rules of the inventive technique. For example, the multicast messages associated with the source processor's node (i.e., a command response) and the home node of the requested data (i.e., a comsig supporting message) are generated as a result of the last packet in the series of multicast packets.

Specifically, the global port includes a routing table that generates a routing word used to determine a path through the central switch fabric for each multicast packet issued by the remote node. That is, each packet transmitted by the node over the central switch fabric has an appended routing word that specifies the path of the packet through the fabric. The routing word contains only information pertaining to forwarding of the packet through a specified physical connection in the switch fabric. To that end, the routing word preferably comprises a vector of N bits, wherein a location of each bit within the vector represents a physical connection to the switch fabric. Thus, an asserted bit of the routing word instructs the switch fabric to forward the packet over the physical connection corresponding to the location of the asserted bit within the vector. If multiple bits in the vector are asserted, the packet is multicasted or transformed into multiple messages at the central switch and each message is forwarded over a physical connection corresponding to an asserted bit location.

In the illustrative embodiment, the multiprocessor system is a symmetric multiprocessor (SMP) system and the central switch fabric is preferably an 8-port crossbar hierarchical switch; therefore, the routing word comprises an 8-bit vector. In addition, the subset of nodes targeted by the multicast messages is at most three (3) nodes of the SMP system and each multicast transaction is decomposed into a series of at most three (3) multicast packets. The global port of each node in the SMP system essentially implements the multicast decomposition rules of the present invention. That is, the global port decomposes (i.e., apportions) the multicast transaction into as many packets needed to satisfy a multicast decomposition rule that the routing word have at most 3bits asserted to denote a 3-way multicast operation. The global port then forwards the multicast packets to the hierarchical switch where they are spawned (i.e., replicated) into multicast messages and distributed to the targeted nodes. Advantageously, the inventive technique allows an 8-port crossbar switch (that cannot support 8-way multicast) to be used in a multiprocessor system that may have up to 8-way destinations of a multicast transaction.

### BRIEF DESCRIPTION OF THE DRAWINGS

The above and further advantages of the invention may be better understood by referring to the following description in conjunction with the accompanying drawings, in which like reference numbers indicated identical or functionally similar elements:

FIG. 1 is a schematic block diagram of a modular, symmetric multiprocessing (SMP) system having a plurality of Quad Building Block (QBB) nodes interconnected by a hierarchical switch (HS);

FIG. 2 is a schematic block diagram of a QBB node, including a directory (DIR) and mapping logic, coupled to the SMP system of FIG. 1;

FIG. 3 is a schematic block diagram of the organization of the DIR;

FIG. 4 is a schematic block diagram of the HS of FIG. 1;

FIG. 5 is a schematic block diagram of internal logic circuits of the HS;

FIG. 6 is a highly schematized diagram illustrating the operation of virtual channels in an embodiment of the SMP system; and

FIG. 7 is a schematic block diagram of a routing table contained within the mapping logic of a QBB node.

### DETAILED DESCRIPTION OF AN ILLUSTRATIVE EMBODIMENT

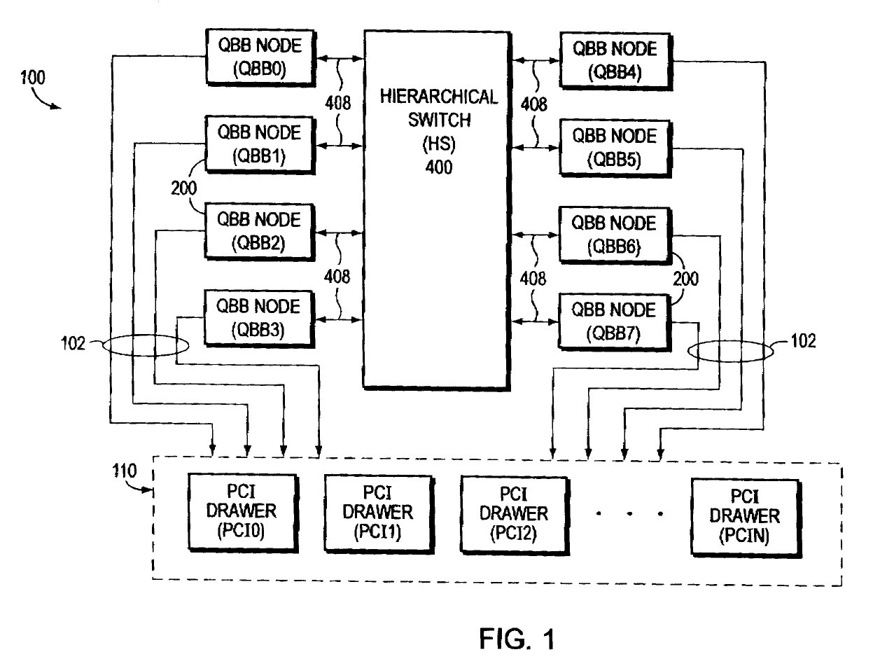

FIG. 1 is a schematic block diagram of a modular, symmetric multiprocessing (SMP) system 100 having a plurality of nodes interconnected by a hierarchical switch (HS 400). The SMP system further includes an input/output (I/O) subsystem 110 comprising a plurality of I/O enclosures or “drawers” configured to accommodate a plurality of I/O buses that preferably operate according to the conventional Peripheral Computer Interconnect (PCI) protocol. The PCI drawers are connected to the nodes through a plurality of I/O interconnects or “hoses” 102.

In the illustrative embodiment described herein, each node is implemented as a Quad Building Block (QBB) node 200 comprising a plurality of processors, a plurality of memory modules, an I/O port (IOP) and a global port (GP) interconnected by a local switch. Each memory module may be shared among the processors of a node and, further, among the processors of other QBB nodes configured on the SMP system. A fully configured SMP system preferably comprises eight (8) QBB (QBB0-7) nodes, each of which is coupled to the HS 400 by a full-duplex, bi-directional, clock forwarded HS link 408.

Data is transferred between the QBB nodes of the system in the form of packets. In order to provide a distributed shared memory environment, each QBB node is configured with an address space and a directory for that address space. The address space is generally divided into memory address space and I/O address space. The processors and IOP of each QBB node utilize private caches to store data for memory-space addresses; I/O space data is generally not “cached” in the private caches.

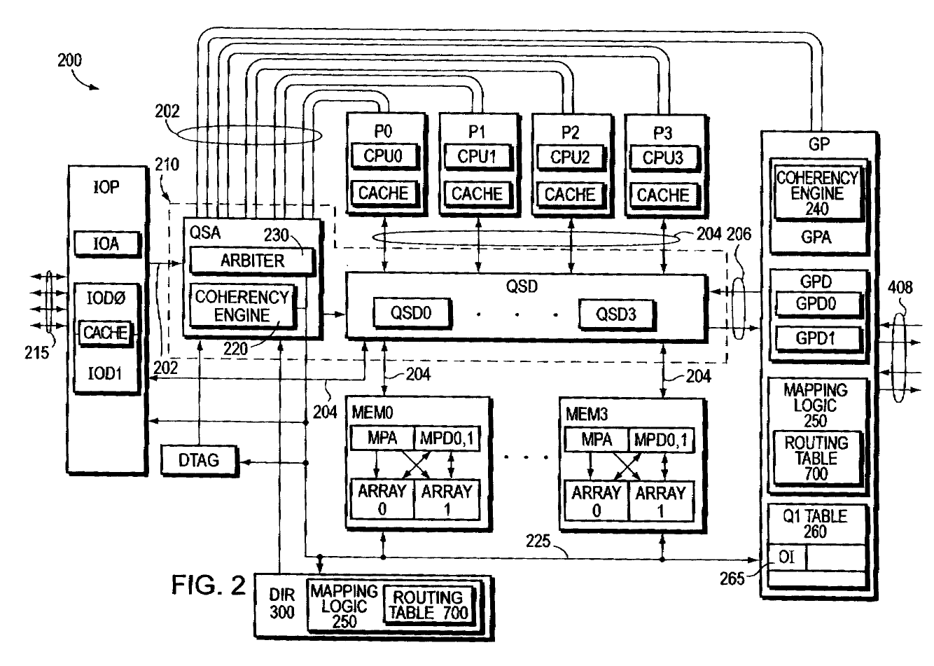

FIG. 2 is a schematic block diagram of a QBB node 200 comprising a plurality of processors (P0-P3) coupled to the IOP, the GP and a plurality of memory modules (MEM0-3) by a local switch 210. The memory may be organized as a single address space that is shared by the processors and apportioned into a number of blocks, each of which may include, e.g., 64 bytes of data. The IOP controls the transfer of data between external devices connected to the PCI drawers and the QBB node via the I/O hoses 102. As with the case of the SMP system, data is transferred among the components or “agents” of the QBB node in the form of packets. As used herein, the term “system” refers to all components of the QBB node excluding the processors and IOP.

Each processor is a modern processor comprising a central processing unit (CPU) that preferably incorporates a traditional reduced instruction set computer (RISC) load/store architecture. In the illustrative embodiment described herein, the CPUs are Alpha® 21264 processor chips manufactured by Compaq Computer Corporation, although other types of processor chips may be advantageously used. The load/store instructions executed by the processors are issued to the system as memory references, e.g., read and write operations. Each operation may comprise a series of commands (or command packets) that are exchanged between the processors and the system.

In addition, each processor and IOP employs a private cache for storing data determined likely to be accessed in the future. The caches are preferably organized as write-back caches apportioned into, e.g., 64-byte cache lines accessible by the processors; it should be noted, however, that other cache organizations, such as write-through caches, may be used in connection with the principles of the invention. It should be further noted that memory reference operations issued by the processors are preferably directed to a 64-byte cache line granularity. Since the IOP and processors may update data in their private caches without updating shared memory, a cache coherence protocol is utilized to maintain data consistency among the caches.

The commands described herein are defined by the Alpha® memory system interface and may be classified into three types: requests, probes, and responses. Requests are commands that are issued by a processor when, as a result of executing a load or store instruction, it must obtain a copy of data. Requests are also used to gain exclusive ownership to a data item (cache line) from the system. Requests include Read (Rd) commands, Read/Modify (RdMod) commands, Change-to-Dirty (CTD) commands, Victim commands, and Evict commands, the latter of which specify removal of a cache line from a respective cache.

Probes are commands issued by the system to one or more processors requesting data and/or cache tag status updates. Probes include Forwarded Read (Frd) commands, Forwarded Read Modify (FRdMod) commands and Invalidate (Inval) commands. When a processor P issues a request to the system, the system may issue one or more probes (via probe packets) to other processors. For example if P requests a copy of a cache line (a Rd request), the system sends a Frd probe to the owner processor (if any). If P requests exclusive ownership of a cache line (a CTD request), the system sends Inval probes to one or more processors having copies of the cache line.

Moreover, if P requests both a copy of the cache line as well as exclusive ownership of the cache line (a RdMod request) the system sends a FRdMod probe to a processor currently storing a “dirty” copy of a cache line of data. In this context, a dirty copy of a cache line represents the most up-to-date version of the corresponding cache line or data block. In response to the FRdMod probe, the dirty cache line is returned to the system and the dirty copy stored in the cache is invalidated. An Inval probe may be issued by the system to a processor storing a copy of the cache line in its cache when the cache line is to be updated by another processor.

Responses are commands from the system to processors and/or the IOP that carry the data requested by the processor or an acknowledgment corresponding to a request. For Rd and RdMod requests, the responses are Fill and FillMod responses, respectively, each of which carries the requested data. For a CTD request, the response is a CTD-Success (Ack) or CTD-Failure (Nack) response, indicating success or failure of the CTD, whereas for a Victim request, the response is a Victim-Release response.

Unlike a computer network environment, the SMP system 100 is bounded in the sense that the processor and memory agents are interconnected by the HS 400 to provide a tightly-coupled, distributed shared memory, cache-coherent SMP system. In a typical network, cache blocks are not coherently maintained between source and destination processors. Yet, the data blocks residing in the cache of each processor of the SMP system are coherently maintained. Furthermore, the SMP system may be configured as a single cache-coherent address space or it may be partitioned into a plurality of hard partitions, wherein each hard partition is configured as a single, cache-coherent address space.

Moreover, routing of packets in the distributed, shared memory cache-coherent SMP system is performed across the HS 400 based on address spaces of the nodes in the system. That is, the memory address space of the SMP system 100 is divided among the memories of all QBB nodes 200 coupled to the HS. Accordingly, a mapping relation exists between an address location and a memory of a QBB node that enables proper routing of a packet over the HS 400. For example, assume a processor of QBB0 issues a memory reference command packet to an address located in the memory of another QBB node. Prior to issuing the packet, the processor determines which QBB node has the requested address location in its memory address space so that the reference can be properly routed over the HS. As described herein, mapping logic is provided within the GP and directory of each QBB node that provides the necessary mapping relation needed to ensure proper routing over the HS 400.

In the illustrative embodiment, the logic circuits of each QBB node are preferably implemented as application specific integrated circuits (ASICs). For example, the local switch 210 comprises a quad switch address (QSA) ASIC and a plurality of quad switch data (QSD0-3) ASICs. The QSA receives command/address information (requests) from the processors, the GP and the IOP, and returns command/address information (control) to the processors and GP via 14-bit, unidirectional links 202. The QSD, on the other hand, transmits and receives data to and from the processors, the IOP and the memory modules via 72-bit, bi-directional links 204.

Each memory module includes a memory interface logic circuit comprising a memory port address (MPA) ASIC and a plurality of memory port data (MPD) ASICs. The ASICs are coupled to a plurality of arrays that preferably comprise synchronous dynamic random access memory (SDRAM) dual in-line memory modules (DIMMs). Specifically, each array comprises a group of four SDRAM DIMMs that are accessed by an independent set of interconnects. That is, there is a set of address and data lines that couple each array with the memory interface logic.

The IOP preferably comprises an I/O address (IOA) ASIC and a plurality of I/O data (IOD0-1) ASICs that collectively provide an I/O port interface from the I/O subsystem to the QBB node. Specifically, the IOP is connected to a plurality of local I/O risers (not shown) via I/O port connections 215, while the IOA is connected to an IOP controller of the QSA and the IODs are coupled to an IOP interface circuit of the QSD. In addition, the GP comprises a GP address (GPA) ASIC and a plurality of GP data (GPD0-1) ASICs. The GP is coupled to the QSD via unidirectional, clock forwarded GP links 206. The GP is further coupled to the HS via a set of unidirectional, clock forwarded address and data HS links 408. As used herein, a switch fabric of the SMP system extends from an input port of a GP on a QBB node through the HS to an output port of the same or another GP on another node. In addition, a “court” of the HS is defined as that portion of the switch fabric extending from queues of the HS to the GP input port of a QBB node.

A plurality of shared data structures are provided for capturing and maintaining status information corresponding to the states of data used by the nodes of the system. One of these structures is configured as a duplicate tag store (DTAG) that cooperates with the individual caches of the system to define the coherence protocol states of data in the QBB node. The other structure is configured as a directory (DIR 300) to administer the distributed shared memory environment including the other QBB nodes in the system. The protocol states of the DTAG and DIR are further managed by a coherency engine 220 of the QSA that interacts with these structures to maintain coherency of cache lines in the SMP system.

Although the DTAG and DIR store data for the entire system coherence protocol, the DTAG captures the state for the QBB node coherence protocol, while the DIR captures a coarse protocol state for the SMP system protocol. That is, the DTAG functions as a “short-cut” mechanism for commands (such as probes) at a “home” QBB node, while also operating as a refinement mechanism for the coarse state stored in the DIR at “target” nodes in the system. Each of these structures interfaces with the GP to provide coherent communication between the QBB nodes coupled to the HS.

The DTAG, DIR, coherency engine, IOP, GP and memory modules are interconnected by a logical bus, hereinafter referred to as an Arb bus 225. Memory and I/O references issued by the processors are routed by an arbiter 230 of the QSA over the Arb bus 225. The coherency engine and arbiter are preferably implemented as a plurality of hardware registers and combinational logic configured to produce sequential logic circuits and cooperating state machines. It should be noted, however, that other configurations of the coherency engine, arbiter and shared data structures may be advantageously used herein.

Specifically, the DTAG is a coherency store comprising a plurality of entries, each of which stores a cache block state of a corresponding entry of a cache associated with each processor of the QBB node. Whereas the DTAG maintains data coherency based on states of cache lines (data blocks) located on processors of the system, the DIR maintains coherency based on the states of memory blocks (data blocks) located in the main memory of the system. Thus, for each block of data in memory, there is a corresponding entry (or “directory word”) in the DIR that indicates the coherency status/state of that memory block in the system (e.g., where the memory block is located and the state of that memory block).

Cache coherency is a mechanism used to determine the location of a most current, up-to-date (dirty) copy of a data item within the SMP system. Common cache coherency policies include a “snoop-based” policy and a directory-based cache coherency policy. A snoop-based policy typically utilizes a data structure, such as the DTAG, for comparing a reference issued over the Arb bus with every entry of a cache associated with each processor in the system. A directory-based coherency system, however, utilizes a data structure such as the DIR.

Since the DIR 300 comprises a directory word associated with each block of data in the memory, a disadvantage of the directory-based policy is that the size of the directory increases with the size of the memory. In the illustrative embodiment described herein, the modular SMP system has a total memory capacity of 256 GB of memory; this translates to each QBB node having a maximum memory capacity of 32 GB. For such a system, the DIR requires 500 million entries to accommodate the memory associated with each QBB node. Yet the cache associated with each processor comprises 4 MB of cache memory which translates to 64 K cache entries per processor or 256 K entries per QBB node.

Thus it is apparent from a storage perspective that a DTAG-based coherency policy is more efficient than a DIR-based policy. However, the snooping foundation of the DTAG policy is not efficiently implemented in a modular system having a plurality of QBB nodes interconnected by an HS. Therefore, in the illustrative embodiment described herein, the cache coherency policy preferably assumes an abbreviated DIR approach that employs distributed DTAGs as short-cut and refinement mechanisms

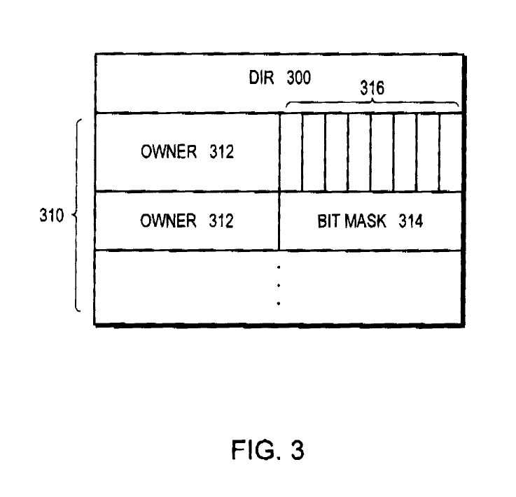

FIG. 3 is a schematic block diagram of the organization of the DIR 300 having a plurality of entries 310, each including an owner field 312 and a bit-mask field 314. The owner field 312 identifies the agent (e.g., processor, IOP or memory) having the most current version of a data item in the SMP system, while the bit-mask field 314 has a plurality of bits 326, each corresponding to a QBB of the system. When asserted, the bit 316 indicates that its corresponding QBB has a copy of the data block. Each time a 64-byte block of data is retrieved from the memory, the DIR provides a directory word (i.e., the directory entry corresponding to the address of the data block) to the coherency engine 220. The location of the data block in memory and the location of the directory entry 310 in the directory are indexed by the address of the request issued over the Arb bus 225 in accordance with a full, direct address look-up operation.

For example, if a processor issues a write request over the Arb bus 225 to overwrite a particular data block (a RdMod or a CTD command), a look-up operation is performed in the DIR based on the address of the request. The appropriate directory entry 310 in the DIR may indicate that certain QBB nodes have copies of the data block. The directory entry/word is provided to a coherency engine 240 of the GPA, which generates a probe command (e.g., an invalidate probe) to invalidate the data block. The probe is replicated and forwarded to each QBB having a copy of the data block. When the invalidate probe arrives at the Arb bus associated with each QBB node, it is forwarded to the DTAG where a subsequent look-up operation is performed with respect to the address of the probe. The look-up operation is performed to determine which processors of the QBB node should receive a copy of the invalidate probe.

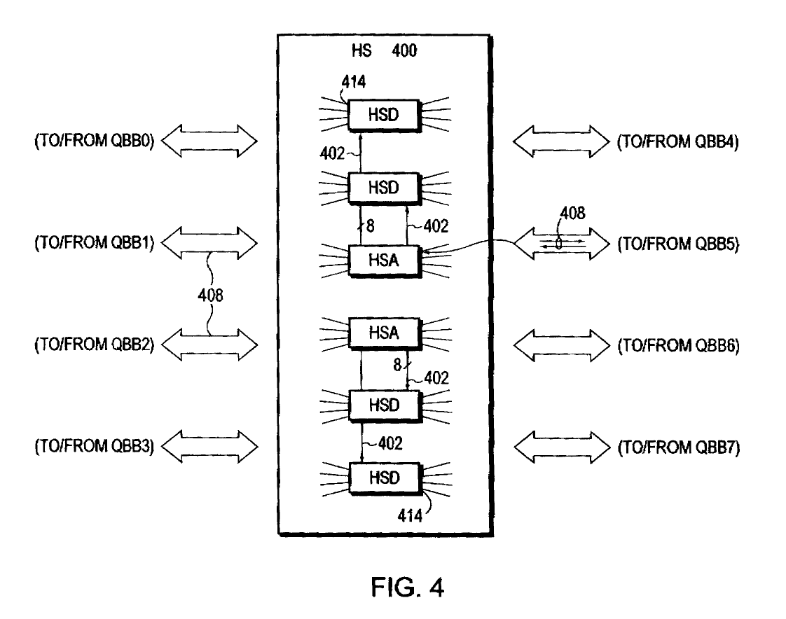

FIG. 4 is a schematic block diagram of the HS 400 comprising a plurality of HS address (HSA) ASICs and HS data (HSD) ASICs. In the illustrative embodiment, each HSA controls two (2) HSDs in accordance with a master/slave relationship by issuing commands over lines 402 that instruct the HSDs to perform certain functions. Each HSA and HSD includes eight (8) ports 414, each accommodating a pair of unidirectional interconnects; collectively, these interconnects comprise the HS links 408. There are sixteen command/address paths in/out of each HSA, along with sixteen data paths in/out of each HSD. However, there are only sixteen data paths in/out of the entire HS; therefore, each HSD preferably provides a bit-sliced portion of that entire data path and the HSDs operate in unison to transmit/receive data through the switch. To that end, the lines 402 transport eight (8) sets of command pairs, wherein each set comprises a command directed to four (4) output operations from the HS and a command directed to four (4) input operations to the HS.

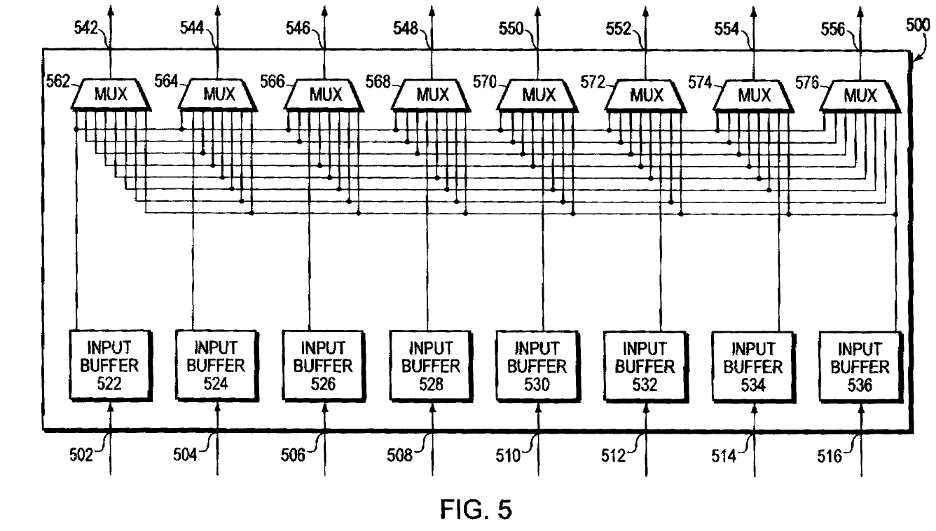

FIG. 5 is a schematic block diagram of the internal logic circuits 500 of the HS comprising a plurality of input ports 502-516 and a plurality of output ports 542-556. The input ports 502-516 receive command packets from the GPs of the QBB nodes coupled to the switch, while the output ports 542-556 forward packets to the GPs. Associated with each input port is a (queue) input buffer 522-536 for temporarily storing the received commands. Although the drawing illustrates one buffer for each input port, buffers may be alternatively shared among any number of input ports. As described herein, a central ordering point is associated with the HS; this enables the switch to impose ordering properties of the system by controlling the order of packets passing through the switch. For example, command packets from any of the input buffers 522-536 may be forwarded in various specified orders to any of the output ports 542-556 via multiplexer circuits 562-576.

The SMP system 100 maintains interprocessor communication through the use of at least one ordered channel of transactions and a hierarchy of ordering points. An ordered channel is defined as a uniquely buffered, interconnected and flow-controlled path through the system that is used to enforce an order of requests issued from and received by the QBB nodes in accordance with an ordering protocol. For the embodiment described herein, the ordered channel is also preferably a “virtual” channel. A virtual channel is defined as an independently flow-controlled channel of transaction packets that shares common physical interconnect link and/or buffering resources with other virtual channels of the system. The transactions are grouped by type and mapped to the various virtual channels to, among other things, avoid system deadlock. Rather than employing separate links for each type of transaction packet forwarded through the system, the virtual channels are used to segregate that traffic over a common set of physical links. Notably, the virtual channels comprise address/command paths and their associated data paths over the links.

In the illustrative embodiment, the SMP system maps the transaction packets into five (5) virtual channels that are preferably implemented through the use of queues. A QIO channel accommodates processor command packet requests for programmed input/output (PIO) read and write transactions, including CSR transactions, to I/O address space. A Q0 channel carries processor command packet requests for memory space read transactions, while a Q0Vic channel carries processor command packet requests for memory space write transactions. A Q1 channel accommodates command response and probe packets directed to ordered responses for QIO, Q0 and Q0Vic requests and, lastly, a Q2 channel carries command response packets directed to unordered responses for QIO, Q0 and Q0Vic request.

Each packet includes a type field identifying the type of packet and, thus, the virtual channel over which the packet travels. For example, command packets travel over Q0 virtual channels, whereas command probe packets (such as FwdRds, Invals and SFills) travel over Q1 virtual channels and command response packets (such as Fills) travel along Q2 virtual channels. Each type of packet is allowed to propagate over only one virtual channel; however, a virtual channel (such as Q0) may accommodate various types of packets. Moreover, it is acceptable for a higher-level channel (e.g., Q2) to stop a lower-level channel (e.g., Q1) from issuing requests/probes when implementing flow control; however, it is unacceptable for a lower-level channel to stop a higher-level channel since that would create a deadlock situation.

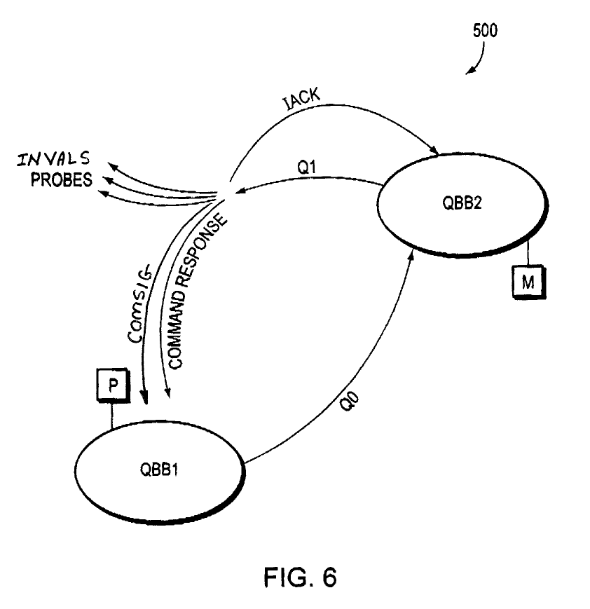

FIG. 6 is a highly schematized diagram illustrating the operation of virtual channels in an embodiment 600 of the SMP system. Assume a processor (P) on a source node, such as QBB1, issues a Q1 command that references a data block of a memory (M) on a home node, such as QBB2. In response to the Q1 command, the home node generates a Q1 command (i.e., a response transaction) that preferably comprises three basic components: (1) a command response, (2) probes/invalidate command, and (3) a commit signal (comsig)/comsig supporting message.

In the case of the command response component, if the Q0 command is a Rd request then the command response is a SFill response and if the Q1 command is a CTD request then the Q1 response is a CTD_success or a CTD_failure response. On the other hand, if the Q1 command is a RdMod request then the Q1 response is a SFillMod response. Thus, the command response component is a response returned to the issuing processor that either delivers the requested data or indicates that the processor can modify (i.e., change the state of) the requested data block. The probe and invalidate commands are sent to other processors having copies of the requested data block to request the data and invalidate the copies of the data. For example in the case of a RdMod request, a FillMod response is not only returned to the processor requesting the data but Inval probes are forwarded to the other processors having copies of the data.

The comsig is a special response that facilitates inter-reference ordering in a shared memory multiprocessor system; moreover, the comsig indicates an apparent completion of a memory reference operation, rather than actual completion of the operation. Notably, the apparent completion of an operation occurs substantially sooner than the actual completion of an operation, thereby improving performance of the multiprocessor system. An example of a multiprocessor system configured to employ commit signals (comsigs) that may be advantageously used with the present invention is described in copending and commonly-owned U.S. patent application Ser. No. 08/957,097, filed Oct. 24, 1997, titled Method and Apparatus for Reducing Latency of Inter-Reference Ordering in a Multiprocessor System, now issued as U.S. Pat. No. 6,108,737, which application is hereby incorporated by reference as though fully set forth herein. An example of the comsig supporting message is an invalidate acknowledgement (IAck).

The hierarchy of ordering points in the SMP system includes local ordering points within the local switches 210 of the QBB nodes 200 and a central ordering point within the HS 400 of the system. To optimize performance, the system may be biased to perform ordering operations at the local ordering points whenever possible. Local ordering is generally possible whenever a processor accesses a memory address location within its own node. However, local ordering may not be possible when a processor accesses a data block from a memory resident in another node. In this case, memory references issued by a source processor and that target memory locations in home nodes use the central ordering point of the HS 400. As such, regardless of where the data is sourced (i.e., from memory or from a cache on another remote node) these references generate a response transaction that is returned to the source processor through the central ordering point over the Q1 ordered channel of the system.

Certain ordering rules are advantageously employed with respect to packets transmitted over the virtual channels. For example, packets transmitted over the Q1 channel are always maintained in order yet packets transmitted over the Q1 channel do not have to maintain a strict order. These rules are particularly relevant to an aspect of the present invention described herein. If a processor attempts to modify a data block that it does not have in its cache, it issues a RdMod command to the QSA to retrieve the data block. The RdMod command retrieves the most current copy of the data block and, further, invalidates other copies of that data block in the system. To that end, the DIR 300 is accessed to determine the locations of the copies of data throughout the system. Once the locations are determined, invalidate (Inval) probes are generated for transmission to those locations and a Fill command is generated for the location having the current data block. Generation of the Inval probes is an example of a multicast packet.

If copies of the data block are stored in caches of processors on other QBB nodes in the system, one invalidate command is forwarded to the HS 400 where it is replicated (multicasted) and forwarded to each of those locations. The probe command forwarded from the home QBB node to the HS includes a routing word identifying those QBB nodes that should receive the multicast probe message. In order to optimize implementation of the SMP system, the HS 400 is configured to provide only a 3-way multicast operation on the probe; therefore, the GP of the home QBB node only sends 3-way multicast packets at a time to the HS. In accordance with this aspect of the present invention, the ordering rules described above are maintained as long as the comsig and the comsig supporting message are transmitted last. In the illustrative embodiment, the portions of the multicast probe operation directed to the source QBB node of the issuing processor, which includes the command response and the comsig, and to the home QBB node, i.e., the comsig supporting message, are transmitted last.

Another ordering rule of the SMP system is that subsequent references to a particular data block inherit all probes that were ordered before a previous reference to that data block. Furthermore, whenever Invals are issued to processors outside of the source QBB node (e.g., in response to a RdMod request to a particular memory block) the IAcks associated with the RdMod request return through the HS to the issuing processor. These IAck responses are ordered through the HS 400 and function to “pull in” any probes that were previously ordered with respect to the issuing processor.

In particular, state information stored at the GP of the source QBB node is associated with the order supporting component of the Q1 response (i.e., the comsig supporting message) and used to detect outstanding ordering components in the SMP system. This “local” state information comprises an outstanding invalidate (OI) bit 265 of a Q1 table 260 within the GP of the QBB node. The OI bit 265 is associated with an address of an entry in the Q1 table that identifies an outstanding Inval in the SMP system. The IAck associated with an outstanding invalidate is used to satisfy the OI bit; that is, when the IAck returns the outstanding invalidate is no longer outstanding and that entry may be removed from the Q1 table 260.

The present invention comprises to a technique for decomposing a multicast transaction issued by a source QBB node into a series of multicast packets, each of which may further “spawn” multicast messages directed to a subset of the nodes. As noted, the HS 400 includes a central ordering point that maintains an order of packets issued by, e.g., a source processor of a remote node when requesting data resident in a memory of a home node. The multicast messages spawned from a multicast packet passing the central ordering point are generated in accordance with multicast decomposition and ordering rules of the inventive technique. These rules specify generation and handling of the multicast packets and messages in a defined manner that ensures ordering in the SMP system.

In the illustrative embodiment, HS is preferably an 8-port crossbar switch and the routing word comprises an 8-bit vector. However, the HS cannot perform a simultaneous 8-way multicast operation directed to its 8 ports because such an operation is expensive in terms of logic circuitry. That is, a substantial amount of additional logic (gates) are needed to perform an 8-way multicast, as opposed to a 3-way multicast transaction, primarily because of the replication logic used within the HS. Therefore, the subset of QBB nodes targeted by the multicast messages is at most three (3) nodes of the SMP system and each multicast transaction is decomposed into a series of at most three (3) multicast packets.

Further to the illustrative embodiment, the queues 522-536 of the HS logic 500 are implemented as link lists and the replication logic preferably comprises these link lists coupled to the multiplexers 562-576. The multiplexers are enabled by the asserted is bits of the routing word; that is, the asserted bits essentially provide pointers within the lists for output ports 542-556 of the HS. An example of logic circuitry associated with the ports of the HS that is suitable for use as replication logic in the illustrative embodiment of the invention is described in copending and commonly-assigned U.S. patent application Ser. No. 08/957,664, filed Oct. 24, 1997, titled, High Performance Non-Blocking Switch with Multiple Channel Ordering Constraints, which application is hereby incorporated by reference as though fully set forth herein.

The multicast messages associated with the components of a Q1 command (i.e., a response transaction) and targeted to QBB nodes of the SMP system are organized into two groups: probe messages and messages that take ownership of the probe messages. The probe messages preferably comprise invalidate and probe read commands, whereas the messages that “take ownership” preferably comprise command responses and comsig supporting messages. Note that the probe read message is used to retrieve dirty data from another processor's cache.

According to the novel rules, the multicast messages are handled in the following order to ensure ordering in the SMP system. First, the HS places all probe messages (invalidate and probe read commands) into the courts of the targeted QBB nodes. Placing of invalidate and probe read commands into the courts of QBB nodes essentially comprises loading these components/messages into input queues of the GPs of the targeted QBB nodes, preferably after these components satisfy the ordering rules of the SMP system.

Second, each QBB node assumes ownership of the probe messages in its court and, thereafter, delivers those messages to the appropriate processors on its QBB node. The messages/components that take ownership of all probes (i.e., the command response and comsig supporting message) are placed in each QBB node court last so that they may “pull in” any probe messages that were previously ordered with respect to the desired data of the request. Therefore, the multicast messages associated with the source processor's node (i.e., a command response) and the home node of the requested data (i.e., a comsig supporting message) are generated as a result of the last packet in the series of multicast packets.

The inventive decomposition technique generally relates to routing of messages (i.e., packets) among QBB nodes 200 over the HS 400. Each node comprises address mapping and routing logic 250 that includes a routing table 700. Broadly stated, a source processor of a QBB node issues a memory reference packet that includes address, command and identification information to the mapping logic 250, which provides a routing mask that is appended to the original packet. The identification information is, e.g., a processor ID that identifiers the source processor issuing the memory reference packet. The processor ID includes a logical QBB label (as opposed to a physical label) that allows use of multiple similar processor IDs (such as processor ID 0) in the SMP system, particularly in the case of a partitioned SMP system. The mapping logic 250 essentially translates the address information contained in the packet to a routing mask (word) that provides instructions to the HS 400 for routing the packet through the SMP system.

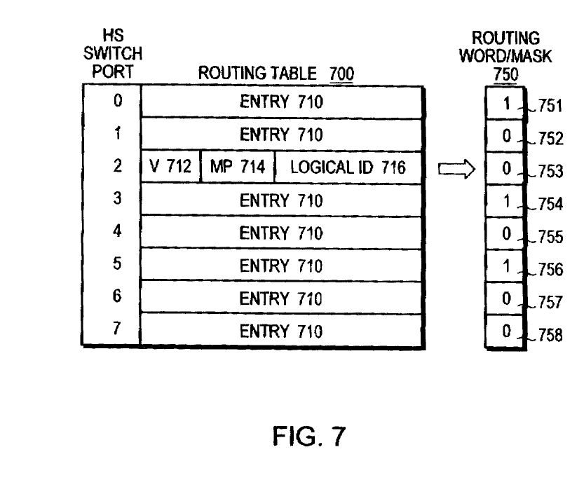

FIG. 7 is a schematic block diagram of the routing table 700 contained within the mapping logic 250 of a QBB node. The routing table 700 preferably comprises eight (8) entries 710, one for each physical switch port of the HS 400 coupled to a QBB node 200. Each entry 710 comprises a valid (V) bit 712 indicating whether a QBB node is connected to the physical switch port, a memory present (MP) bit 714 indicating whether memory is present and operable in the connected QBB node, and a memory space number or logical ID 716. The logical ID represents the starting memory address of each QBB node 200. An example of a routing table that may be advantageously used with the present invention is described in copending U.S. patent application Ser. Nos. (15311-2229U1), filed Mar. 21, 2001, titled, A Distributed Address Mapping and Routing Table Mechanism that Supports Flexible Configuration and Partitioning in a Modular, Switch-Based Shared-Memory Multiprocessor Computer System, which application is hereby incorporated by reference as though fully set forth herein.

The GP of each QBB node essentially implements the multicast decomposition and ordering rules described herein. For example, assume that as a result of performing a routing/forwarding decision at the GP of a QBB node, the resultant routing word 750 has more than 3 bits asserted. The GP decomposes (i.e., apportions) the multicast transaction into as many packets needed to satisfy a multicast decomposition rule that the routing word 750 have at most 3 bits asserted to denote a 3-way multicast operation. That is, the GP generates multiple multicast packets, each having at most 3 bits asserted in its associated routing word.

The GP further implements the novel rules by ensuring that the last packet issued to the HS includes a routing word bit asserted for the remote node of the requesting processor (i.e., the command response) and the home node of the requested data (i.e., the comsig supporting message). The GP issuing the multicast packet is located on the home QBB node of the requested data, while the requesting processor's remote node appears in the original request for the desired data. The GP then forwards the multicast packets to the HS where they are spawned (i.e., replicated) into multicast messages and distributed to the target destination nodes. Upon receiving the multicast packet, the HS does not make progress until all messages (components) of that multicast packet are simultaneously placed into the courts of the targeted QBB nodes.

In summary, the HS is configured to perform at most a 3-way multicast operation at a time, even though a multicast transaction may comprise more than 3 target multicast messages/components. If there are only 3 messages/components associated with a multicast transaction, then the HS can issue those components simultaneously; however, if there are more than 3 components, the HS must issue those components in at least 2 different multicast packet operations. In a situation where there are more than 3 target QBB node destinations of a multicast transaction, the present technique specifies forwarding the probe read and invalidate components first, with the command response and comsig supporting message components forwarded last. Thus, the invention advantageously allows an 8-port crossbar switch (that cannot support 8-way multicast) to be used in a multiprocessor system that may have up to 8-way destinations of a multicast transaction.

What is claimed is:

1. A method for decomposing a multicast transaction into multicast messages directed to targeted nodes of a distributed shared memory multiprocessor system, the multicast transaction issued by a source node of the system to acquire data stored on a home node of the system, the method comprising the steps of:
apportioning the multicast transaction into a predetermined number of multicast packets at a global port of the home node;
forwarding the multicast packets to a central switch fabric interconnecting nodes;
generating the multicast messages from the packets at the central switch fabric, the multicast messages generated according to multicast decomposition and ordering rules; and
distributing the multicast messages to the targeted nodes.

2. The method of claim 1 wherein:
the multicast messages include a commit signal (comsig) and one or more comsig supporting messages, and
the comsig and the one or more comsig supporting messages are distributed last.

3. The method of claim I wherein the step of generating the multicast messages comprises the step of generating the multicast messages associated with the source node and the home node as a result of the last packet in the predetermined number of multicast packets.

4. The method of claim 1 wherein the multicast message associated with the source node is a command response message and wherein the multicast message associated with the home node is a comsig supporting message.
